(19) United States
(12) Patent Application Publication
(10) Pub. No.: US 2012/0160361 A1
(43) Pub. Date: Jun. 28, 2012

(54) Construction and Manufacturing of Long Tubes with Embedded Corrosion- and Wear-Resistant Coatings Applied Directly to the Interior Surfaces

(76) Inventors: George Fischer, Shaker Heights, OH (US); Alexander E. Shapiro, Hilliard, OH (US)

(21) Appl. No.: 12/980,323

(22) Filed: Dec. 28, 2010

(51) Int. Cl. F16L 9/14; B32B 37/12; B32B 37/14; B32B 37/06; B32B 1/08; B23K 20/24; B23K 1/20; B23K 20/12; B23K 31/02; B32B 37/02; B32B 38/10

(52) U.S. Cl. 138/145; 156/293; 156/196; 156/221; 156/73.5; 156/247; 228/203; 228/194; 228/114; 428/34.1; 428/686; 428/650; 428/656

(57) ABSTRACT

The invention relates to the manufacture of protective coatings onto interior surface of long-length tubes or pipes having relatively small diameter, in order to prevent corrosion-, erosion-, or wear damage of said surface. The method for manufacturing a tube comprising an embedded corrosion-resistant and wear-resistant-coating, wherein the tube consists of an external tube layer, a bond layer, a corrosion- and wear-resistant coating, and an internal tube layer, includes: depositing the corrosion- and wear-resistant coating (CWRC) onto outer surface of the internal tube, depositing a bonding material onto CWRC, inserting the internal tube with deposited CWRC and bond material into the external tube to provide an embedded CWRC between external and internal tube layers, and bonding both tubes with the interior CWRC in one solid structure. A crack-healing compound or release compound is additionally deposited onto internal tube before CWRC, which is preferably alumina ceramic or hard thermal-sprayed alloy. CWRC can be multilayer coating that includes said internal tube embedded between CWRC layers.

### FIELD OF INVENTION

The present invention relates to the manufacture of protective coatings applied directly to the interior surface of long-length tubes or pipes having relatively small diameter, in order to prevent corrosion-, erosion-, or wear damage of said surface. The invention concerns protection of tubes or pipes made from any material: metals, ceramics, plastics (polymers), carbon and graphite, glass, quartz, clays, plain or reinforced concretes, composites or hybrid materials or structures of any type, including single-layer or multilayer tubes or pipes of any shape of their profile.

### BACKGROUND OF THE INVENTION

Industrial tubes and pipes are widely used to transport corrosive and abrasive materials in liquid, solid, or gaseous states. In many applications, the transported compounds are presented in the form of suspensions, slurries, or slimes that are combinations of liquid and solid states. Examples are tubes and pipelines used in mining and ore beneficiation exposed to highly abrasive and often chemically active mineral mixtures, cement kiln pipe systems, burner heads of coal fired boilers exposed to highly abrasive aqueous coal slurry, paper manufacture exposed to corrosive and abrasive pulp, oil and gas production exposed to hot corrosive liquids and abrasive mud, wastewater treatment exposed to corrosive, abrasive and chemically and biologically active slimes, and many other applications. Barrels and some other parts of fire arms which are in contact with the projectile and hot, corrosive gases are examples of mixed exposure to solid-gas mixtures under extreme conditions during transport of materials.

Protection of the exterior surface of tubes and pipes against corrosion or abrasion wear is well developed in the industry. It can be done by many known methods such as plasma- or thermal spraying (including HVOF) corrosion- and abrasion resistant hardfacing coatings, ceramic coatings, diffusion coatings (e.g., nitriding or carbonitriding), PVD (physical vapor deposition) coating, and others.

However, protection of the interior surface of tubes and pipes, especially of relatively small diameters at relatively big length, is a problem that is still not resolved in the industry. This is caused by several reasons: (a) the access to the interior of small diameter tubes is limited and sometimes impossible for the coating depositing devices; (b) process- and coating quality control are also limited or impossible; (c) heating to high temperature needed for diffusion or sol-gel coatings is also limited or impossible for a broad range of materials, such as aluminum, plastic, and some steel pipes due to a loss of their strength or their total destruction by high temperature.

Therefore, a method for depositing protective, corrosion-, abrasion, and wear-resistant coatings onto the interior surface of tubes and pipes is an actual engineering task that should be resolved and can be suitable for many industrial applications.

Some methods of the deposition of protective coatings on the interior surface of tubes and pipes was developed in prior art. For example, aluminide and MCrAlY diffusion layers are deposited on the inner surface of steel tubes by filling the tube with a mixture of aluminum, alumina Al₂O₃, and flux powders and diffusion treatment at 800-1100° C. for 10 hours (see U.S. Pat. No. 5,409,748). This method is unsuitable for tubes manufactured from aluminum, plastics, or glass, because these base materials have melting temperature or glass softening temperature well below the above mentioned temperature of diffusion treatment. Low carbon steel tubes can be coated at the high diffusion treatment temperature, while the method is unacceptable for high-strength steels or stainless steel tubes that loose their requisite mechanical properties due to annealing at the temperature of diffusion treatment.

Deposition of a glass-ceramic coating composition onto the interior surface of a steel tube is proposed in the U.S. Pat. No. 6,410,171 granted to T. E. Paulson. The method involves the use of molten glass at 1650° C., so it is not suitable for aluminum tubes, plastic tubes, or high-strength steel tubes due to an unacceptable heat impact on this tube materials. Besides, glass-ceramic coating is very brittle, and the adhesion to the tube surface is uncontrollable.

There is also a method of depositing ceramic refractory coating on both exterior and interior surfaces of steel tubes at a relatively low temperature by immersing the tube into a water solution of clay-based components followed by drying at 250-600° F. (U.S. Pat. No. 5,295,669). However, only silicate (especially alkali silicate) coating can be deposited via this way, which is useless for corrosion protection because silicates are soluble in water and in most of acids.

All other known compositions and methods for producing interior coatings on small-diameter tubes have the same drawbacks: heat impact with subsequent loss of strength of the base materials, no control over the process and the coating quality, poor adhesion to the tube surface, and brittle coatings. Also, all prior art compositions and methods are not cost-effective; they require multi-step operation, which generates a need in specialized large and energy-intensive equipment. Besides, all processes known from the prior art do not provide high productivity together with process reproducibility and stable quality of the coating. These problems make none of prior-art processes effective.

However, the most serious disadvantage of conventional coating methods is that no one of them can deposit fully-dense, highly corrosion-resistant and wear resistant ceramic coatings onto the interior surface of tubes and pipes.

Such ceramics as alumina, silicon nitride, or silicon carbide have best corrosion- and abrasion resistance among commonly available materials. Therefore, the tube construction containing fully-dense ceramic coating on its interior surface will provide a significant improvement in corrosion- and wear resistance, and hence will significantly increase the service life of expensive tubes and pipelines.

But as we said earlier no conventional process can deposit fully-dense alumina ceramic coating on the interior tube surface at room temperature or at low temperatures.

### SUMMARY OF THE INVENTION

The object of the invention is to manufacture dense anticorrosive and wear-resistant coatings on the interior surface of small-diameter, long tubes and pipes used for transportation of corrosive and abrasive substances. Additional high-temperature treatment of the base (substrate) material should be excluded, while the most effective ceramic coating materials can be utilized readily. Also, no specialized devices should be used inside the tube.

Yet another objective of the present invention is the possibility to use the same equipment as used for the manufacture of the tubes and pipes themselves and the exterior coating on tubes and pipes.

It is also an objective to provide cost-effective and highly-productive manufacture of dense anticorrosive and wear-resistant coatings on the interior surface of small-diameter, long tubes and pipes made from any base material: metals, ceramics, glass, plastics, composites, or hybrid materials.

Also, the possibility to apply deformation either to expand the diameter or to bend the coated tubes should be undertaken.

The nature, utility, and further features of this invention will be more apparent from the following detailed description, with respect to preferred embodiments and examples of the invented technology.

According to our invention, the construction of a small-diameter tube with an embedded corrosion- and wear-resistant coating for protecting the interior surface of long tubes comprises: (a) an external tube layer, (b) a bond layer, (c) a corrosion- and wear-resistant coating, and (d) an internal tube layer, wherein the corrosion- and wear-resistant coating (CWRC) is bonded to the outside surface of the internal tube layer, and the thickness of the external tube layer is equivalent or larger than that of the internal tube layer.

Actually, the coating designed to protect an interior surface of a base small-diameter tube has a multilayer structure including the corrosion- and wear resistant coating and internal tube layer. The internal tube layer plays a service role and it is a sacrificial component of said protective coating. The CWRC is the exterior coating relative to the internal tube, while the same CWRC is interior coating relative to the external tube. The function of internal tube is to bring the CWRC inside the base tube because it is easy to deposit an exterior coating on this tube than on the interior surface of the base tube, as we mentioned above.

When CWRC and the internal tube are bonded to the base tube 1, they form a multi-layer protective coating of the interior surface of the base tube, thus the protective coating is embedded in the tube construction.

Bonding of all structure components is made by any known method. The bond layer is made from at least one material selected from solders, brazing filler metals, organic adhesives, inorganic adhesives, cellulose binders, hydraulic binders including cement-based binders, composite solders, hybrid organic-inorganic adhesives and binders, and mixtures thereof. Any other compounds suitable as binding agents can also be applied.

Finally, the tube construction comprises a base small-diameter tube, CWRC, which protects the interior surface of this tube, bond layer, and the internal tube that can be removed or left in place as is and can act as a sacrificial component of the final product.

After bonding the internal tube can either stay in the construction and become its part or it can be removed from the construction. Removal of the internal tube can be accomplished by separating it from the deposited CWRC. In order to make the separation possible, a low melting temperature material is deposited onto the outside surface of the internal tube before the deposition of CWRC. In this case, the internal tube can be removed from the whole construction by heating to melt this intermediate material layer and release the internal tube.

The low melting temperature material also plays the role of crack-healing material needed to fill cracks that might appear in ceramic CRWC or in any other hard material used as CWRC. It is important to note that the melting temperature or the liquidus temperature of the crack-healing material should be lower that that of the bond layer between CWRC and the external tube. Glass or glass-ceramics, low melting temperature metals and alloys, solders, brazing fluxes, soldering fluxes, adhesives, plastics, reinforced plastics, or mixture thereof are used as the crack-healing material.

Both external and internal tube layers can be made from the same material or from different materials, but definitely, the material of CWRC should have corrosion resistance and wear-resistance superior to the external tube layer.

If the internal tube layer is made from glass or glass-ceramic, preferably glass tube, the internal tube can be removed from the construction by breaking the glass. In this case, the intermediate low melting temperature material between CWRC and the internal tube is not needed.

A method for manufacturing a tube construction comprising an embedded corrosion-resistant and wear-resistant-coating includes the following steps:
(a) depositing the corrosion- and wear-resistant coating (CWRC) onto the exterior or outer surface of the internal tube using any of known techniques, such as plasma spraying, thermal spraying, sintering, thermo-chemical diffusion treatment, sol-gel coating, welding surfacing and hardfacing, arc deposition, etc.
(b) depositing a bonding material onto CWRC,
(c) inserting the internal tube with deposited CWRC and bond material into the external tube to provide an embedded CWRC between external and internal tube layers, and
(d) bonding the external tube with the internal tube having deposited CWRC and bond material.

A crack-healing agent is deposited onto the surface of internal tube before the CWRC deposition or together with the corrosion- and wear-resistant coating.

Before or after bonding, the internal tube can be subjected to deformation by increasing its diameter or bending. The deformation is carried out after heating the tube to the temperature above the temperature of ambient atmosphere. The deformation aims to provide intimate contact between CWRC and the external tube in order to obtain strong joining, as well as to obtain a pre-determined shape and size of the final tube construction.

### BRIEF DESCRIPTION OF DRAWINGS

FIG. 1 is a schematic cross-sectional view of a tube construction with an embedded corrosion- and wear-resistant coating (CWRC) that protects the interior surface of the base external tube.

FIG. 2 is a schematic cross-sectional view of a tube construction with an embedded corrosion- and wear-resistant coating that protects the interior surface of the base external tube, comprising an additional crack-healing layer.

FIG. 3a and FIG. 3b are schematic cross-sectional views of a tube construction with an embedded corrosion- and wear-resistant coating that protects the interior surface of the base tube; and comprising an internal glass or plastic tube layer (FIG. 3a), which is removed after bonding to increase the inside diameter of the structure and expose CWRC to the material flowing in the tube or pipe (FIG. 3b).

FIG. 4 is a schematic cross-sectional view of a tube construction with an embedded corrosion- and wear-resistant coating (CWRC) that protects the interior surface of the base tube, and an internal tube layer, which is embedded between two CWRC layers and forms a multilayer design of protecting coating.

### DETAILED DESCRIPTION OF THE EMBODIMENTS

The present invention is concerned with protecting an interior tube surface from corrosion, abrasion or wear. Accordingly, the invention is described with respect to that specific utility, but the broader application will be apparent to those concerned with the protection of tubes and pipes.

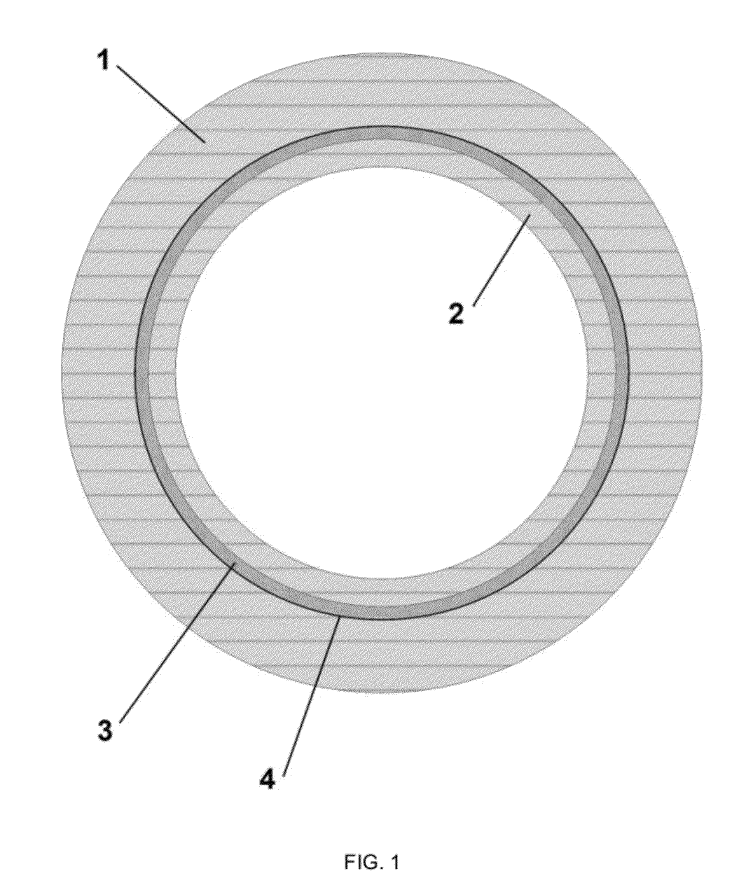

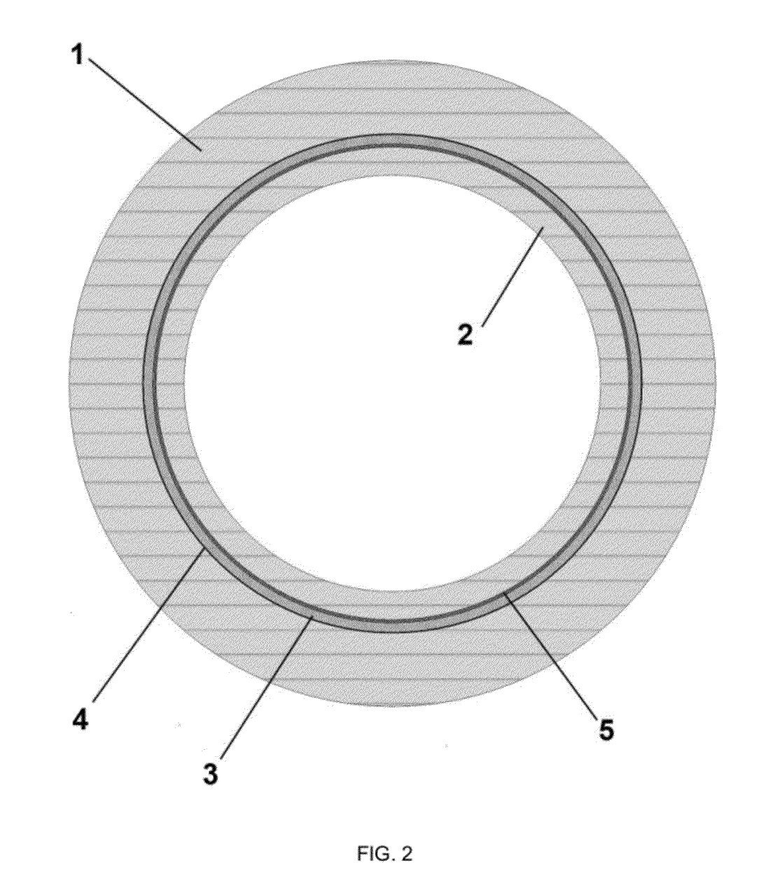

Referring to the FIGS. 1-4, wherein appropriate numerals refer all components of the invented tube structure, a method of forming a corrosion-, abrasion-, and wear-resistant coating on the interior surface of a tube construction is described herein. Positions in all Figures refer the following components: 1—external tube, 2—internal (sacrificial) tube, 2′—internal glass, glass-ceramic, and plastic tube, 3—CWRC layer, 4—bond layer, 5—crack-healing compound layer, and 6—second CWRC layer.

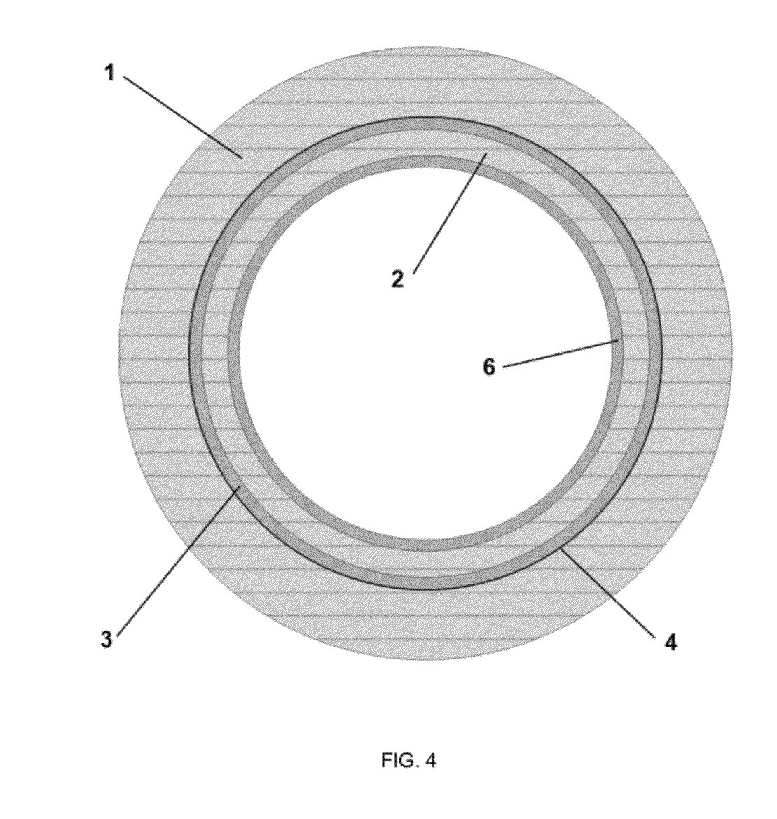

The method is suitable for forming interior corrosion- and wear-resistant coatings (ICWRC) either as single layer coating 3 (FIG. 1-3) or multilayer coating 3 and 6 (FIG. 4).

A base tube or pipe 1 in FIG. 1-3 to be protected can be manufactured from any structural materials such as carbon steel, alloy steel, stainless steel, cast iron, titanium and titanium alloys, aluminum and aluminum alloys, copper or copper alloys, refractory metals and alloys, plastics and polymers, reinforced plastics and polymers, glass, ceramics, refractory inorganic materials, metal matrix composites, ceramic composites, hybrid materials, and any combinations thereof.

A corrosion- and wear-resistant coating (CWRC) 3 is firstly deposited onto the exterior surface of a tube 2 or 2′ having smaller diameter than that of the base tube to be protected. Then, the tube 2 or 2′ is assembled with (inserted into) with the base tube 1 by using a bonding compound 4. After hardening this bonding compound, the interior surface of base tube 1 becomes protected by CWRC.

The length, diameter, and shape of the base tube 1 are not limited. For instance, an interior protecting coating of tube having square or rectangular cross-section can also be manufactured using the invented method.

The method according to the present invention uses a primary deposition of corrosion-, abrasion-, and wear-resistant coatings onto the exterior surface of smaller tube instead of the deposition such coatings onto the interior surface of the base tube. This approach allows using conventional methods and equipment for coating deposition instead of designing highly specialized devices and processes for coating deposition inside the long, small-diameter tubes, that is often difficult or even impossible. After the assembling the coated internal tube 2 or 2′ and base external tube 1 and fixing the entire structure by bonding layer 4, we obtain the final tube construction (FIG. 1-4) comprising a base tube 1 and an interior protecting coating 3.

The type and nature of an internal tube material and coating material is not limited. The present invention allows the application of any tube and coating material, moreover one material can be easily substituted for another one immediately in manufacture, without cost-increasing setup.

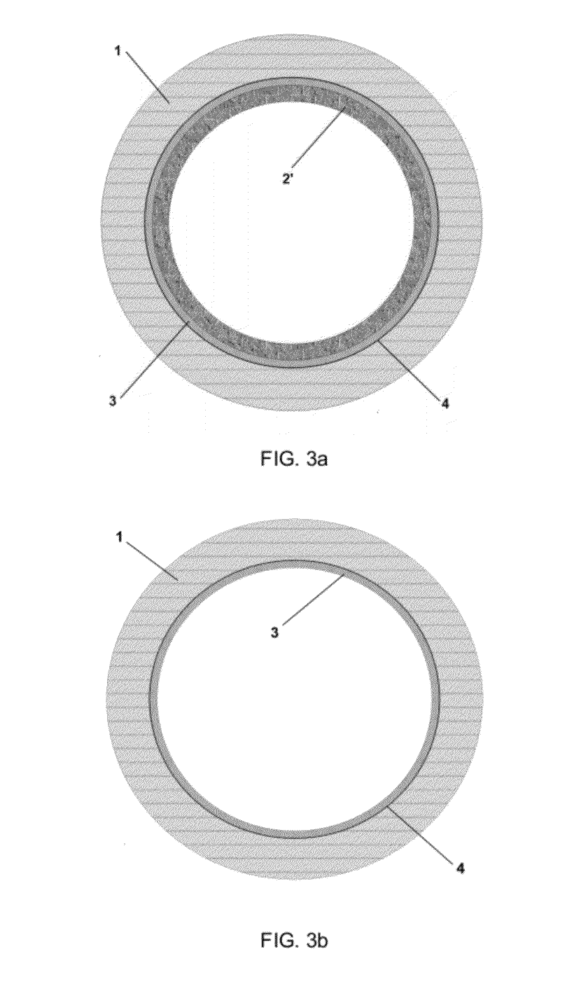

The internal tube 2 or 2′ plays a service role, and it can be removed from the resulting construction or left in place as is. If the internal tube 2′ is manufactured from a plastic or glass as it shown in FIG. 3, it can be easy removed from the resulting construction. If the internal tube 2 is manufactured from metals, it can be incorporated permanently in the resulting product and exposed to corrosive- or abrasive wear by compounds transported through the tube, because the internal tube is a sacrificial component of the resulting product.

According to the present invention, in order to provide removal of the internal tube 2 from the resulting construction, an additional component is used. This releasing component is a compound material having melting temperature or liquidus temperature lower than that of the CWRC material. This component 5 is deposited onto external surface of the tube 2 before the deposition of CWRC, or it can be deposited together with CWRC, for example, as a component of ceramic powders used for thermal spraying. If necessary the internal tube can be removed from the final product by heating to melt the releasing component 5, that will allow to separate the tube 2 from coating 3.

This low melting temperature material is made from at least one material selected from the group consisting of low-melting temperature glass or glass-ceramics, low-melting temperature metals and alloys, solders, brazing fluxes, powders, soldering fluxes, rosin, adhesives, plastics, reinforced plastics, or mixture thereof.

The same low-melting temperature component 5 plays the role of crack-healing material to fill cracks that may appear in brittle ceramic or hard-facing alloy of CWRC during the manufacture, especially if deformation is applied to the tube construction.

When the internal tube 2 is made from a plastic material (metals, plastics, metal matrix composites, reinforced plastic composites, or other materials), it can be subjected to deformation by increasing its diameter after inserting the tube 2 with coating 3 into the external tube 1 either before or after bonding the internal and external tube layers. This operation provides full contact between the assembled components that results in improvement of bonding and quality of the final product. Also, the deformation can be used to change the shape or diameter of the final product, as necessary. Bending deformation can also be applied to the tube construction after inserting the internal tube 2 with CWRC into the base tube 1 either after or before bonding. Any type of deformation: bending deformation of the tube, tube diameter-expanding deformation, and tube shape-changing deformation can be done either at ambient temperature and at the temperature higher than ambient temperature.

The following examples are meant to illustrate the invention and are not to be viewed in any way as limiting the scope of the present invention.

### EXAMPLE 1

A carbon steel tube construction consists of:
an external tube 1 having 38 mm OD and wall thickness of 3 mm,
an internal tube 2 having 30 mm OD and wall thickness 0.5 mm,
a corrosion- and wear resistant coating (CWRC) layer 3 between external and internal tubes, so the CWRC coating is embedded within the tube structure,
a bond layer 4 which is an adhesive joint layer about 0.05 mm thick between CWRC and the inner surface of the external tube. The length of tubes is 120 mm.

The corrosion- and wear resistant coating (layer 3) is high abrasion- and corrosion resistant Sulzer Metco® 5803, which is a Tungsten Carbide+a Nickel-based Hastelloy matrix.

The manufacture of the tube construction included the following steps:
(a) Plasma spray deposition of Sulzer Metco® 5803 onto the outer surface of the internal tube to form CWRC, with a thickness of about 1 mm;
(b) Depositing an adhesive, such as Aremco® Epoxy #2300 on top the CWRC surface;
(c) Assembling the structure by inserting the internal tube with CWRC and adhesive into the external tube, and
(d) Bonding the two tubes at room temperature to produce a single solid multilayer tube with the corrosion- and wear-resistant coating embedded between the two steel layers.

### EXAMPLE 2

A high-strength 4140 alloy steel tube construction consists of the same diameters external and internal tubes as in Example 1, but CWRC is plasma sprayed alumina and the bond layer is an inorganic alumina-based or silicate-based adhesive:

The manufacture of the tube construction included the following steps:
(a) Plasma spray deposition of alumina ceramic powder onto the outer surface of the internal tube to form dense ceramic CWRC, with a thickness of CWRC layer is about 1 mm;
(b) Depositing the inorganic adhesive (Aremco® Ceramacast 510) onto the CWRC surface;
(c) Inserting the internal tube with CWRC and adhesive into the external tube, and
(d) Bonding the two tubes at 100-120° C. for 3 h to produce a single solid multilayer tube with the corrosion- and wear-resistant coating embedded between two steel layers.

### EXAMPLE 3

A carbon steel tube construction consists of the same external and internal tubes as in Example 1, but CWRC is plasma sprayed alumina and the bond layer is an inorganic alumina-based or silicate-based adhesive. Besides, a thin layer of low melting temperature glass is deposited onto the OD of internal tube before deposition of alumina. This low melting temperature glass acts as a crack-healing agent.

The manufacture of the tube construction included the following steps:
(a) tube by immersing the tube into molten glass bath;
(b) Plasma spray deposition of alumina ceramic powder onto the outer surface of the internal tube to form dense ceramic CWRC, with a thickness of about 1 mm;
(c) Depositing the inorganic adhesive (Aremco® Ceramacast 510) onto the CWRC surface;
(d) Assembling by inserting the internal tube with CWRC and adhesive into the external tube, and
(e) Bonding the two tubes at 100-120° C. for 3 h to produce a single solid multilayer tube with the corrosion- and wear-resistant coating embedded between the two steel layers.

### EXAMPLE 4

A carbon steel tube construction consists of the same external and internal tubes as in Example 1, whereby CWRC is plasma sprayed alumina and the bond layer is an inorganic adhesive. Besides, a thin layer of low melting temperature glass is deposited onto the OD of internal tube before deposition of alumina. This low melting temperature glass is used as a crack-healing agent to fill cracks that appear in CWRC after deformation. The internal tube is expanded by a mandrel with appropriate diameter during bonding or immediately after assembly to press the OD of the internal tube to the ID of the external tube to provide better bonding between the tubes. Possible cracking of ceramic CWRC is repaired by heating the final assembly to melt the glass which fills all cracks.

The manufacture of the tube construction included the following steps:
(a) Depositing the low melting temperature glass onto the OD of internal tube by immersing the tube into molten glass bath. The ID surface can also be coated during this operation;

(b) Plasma spray deposition of alumina ceramic powder onto the outer surface of the internal tube to form dense ceramic CWRC, with a thickness of about 1 mm;
(c) Depositing the inorganic adhesive (Aremco® Ceramacast 510) onto the CWRC surface;
(d) Inserting the internal tube with CWRC and adhesive into the external tube,
(e) Expanding the assembled tube structure to increase its diameter by 10-12% to improve the bond quality by providing full contact between CWRC and inner surface of the external tube, and at the same time sizing the internal diameter of the structure,
(f) Bonding the two tubes at 100-120° C. for 3 h to produce a single solid multilayer tube with the corrosion- and wear-resistant coating embedded between the two steel layers, and
(g) Heating the finally made multilayer tube structure comprising the embedded corrosive- and wear-resistant coating to a temperature above the glass melting point in order to provide healing possible cracks in ceramic CWRC by liquid glass, followed by solidification of the glass during cooling the multilayer tube.

### EXAMPLE 5

All materials and operation steps from (a) to (f) were the same as in Example 4. The step (g) was performed by a different way: (g) Heating the finally made multilayer tube structure comprising the embedded corrosive- and wear-resistant coating to a temperature above the glass melting point in order to provide healing possible cracks in ceramic CWRC by liquid glass, followed by removing the internal tube from the assembly before the solidification of the glass, and this step is followed by step (h) Solidification of glass during cooling the multilayer tube.

Removing the internal tube 2 from the assembly can also be done if a solder is used as a crack-healing agent. In this case the multilayer tube structure is heated to melt the solder, and the internal tube is removed while the solder is still in a liquid state. Also, a plastic or any other material having melting point below that of the CWRC and the tube material can be used as a crack-healing agent, and the internal tube will be removed from the assembly after melting said crack-healing agents.

### EXAMPLE 6

An alloy steel 4140 tube construction consists of:
an external tube 1 having 60 mm OD and wall thickness of 4 mm,
an internal tube 2 having 48 mm OD and wall thickness 1 mm,
a corrosion- and wear resistant coating (CWRC) layer 3 between external and internal tubes, so the CWRC coating is embedded in the tube structure,
a crack-healing layer 5 deposited onto the outside surface of the internal tube,
a bond layer 4 which is an adhesive joint layer about 0.05 mm thick is deposited between

CWRC and the inner surface of the external tube. The length of tubes is 800 mm. The corrosion- and wear resistant coating is WOKA® 7505 supplied by Sulzer Metco®. This is a Tungsten carbide/Chromium carbide+a Nickel-based superalloy; this material has high abrasion and corrosion resistance.

The crack-healing layer is a lead-free solder Sn—3.5Ag, and the bond layer is an inorganic adhesive having softening temperature higher than melting point of said lead-free solder.

The tube construction included the following steps:
(a) Depositing the solder Sn—3.5Ag layer about 0.5 mm thick onto the OD of internal tube by immersing the tube firstly into the flux solution, and then, into the solder pot. The soldering flux #71 supplied by Superior Flux Mfg. Co. was used for this operation;
(b) HVOF thermal spray deposition of WOKA® 7505 composition onto the outer surface of the internal tube coated with solder Sn—3.5Ag in order to form CWRC with thickness of about 1.5-1.6 mm;
(c) Depositing the inorganic adhesive (Aremco® Ceramacast 510) onto the CWRC surface;
(d) Assembling by inserting the internal tube with CWRC and adhesive into the external tube,
(e) Bonding the tubes at 100-120° C. for 3 h to produce a single solid multilayer tube with the corrosion- and wear-resistant coating embedded between the two steel layers;
(f) Bending the multilayer tube structure to form a 30° bent tube;
(g) Heating the finally made multilayer, bent tube comprising the hidden corrosive- and wear-resistant coating to the temperature of 240-250° C. for melting the solder in order to provide healing possible cracks in CWRC by liquid solder, followed by solidification of the solder during cooling the multilayer tube.
The resulting product is high-strength steel tube with the embedded, interior 1.5 mm thick WOKA® 7505 coating, and 1 mm thick steel sacrificial layer.

### EXAMPLE 7

All materials and operation steps from (a) to (f) were the same as in Example 6. The step (g) was performed by a different way: (g) Heating the finally made multilayer tube structure comprising the embedded corrosive- and wear-resistant interior coating to the temperature above the melting point of Sn—3.5Ag solder in order to provide healing possible cracks in ceramic CWRC by the liquid solder, followed by removing the internal tube from the assembly before solidification of the solder, and this step is followed by step (h) Solidification of glass during cooling the multilayer tube. In order to provide wetting of the ceramic or another corrosion-resistant CWRC material, the solder composition contains an activator or flux. The resulting product is high-strength steel tube with the interior 1 mm alumina coating.

### EXAMPLE 8

An alloy steel 4140 tube construction consists of:
an external steel 4140 tube 1 having 50 mm OD and wall thickness of 3 mm,
an internal steel 4140 tube 2 having 44 mm OD and wall thickness 2 mm,
corrosion- and wear resistant coating (CWRC) layers 3 and 6 with the internal tube 2 embedded between coating layers, which means that one coating layer is embedded in the tube structure, while the other coating layer is located on the interior surface of the tube construction,
a bond layer 4 which is an adhesive joint layer about 0.05 mm thick between CWRC and the inner surface of the external tube. The length of tubes is 800 mm.

The corrosion- and wear resistant coating layers are carbide-nitride coatings manufactured by diffusion thermal treatment of the internal tube in the carbonitriding atmosphere at 845-860° C. The hard carbide-nitride surface layers formed on both sides of the internal steel tube have high abrasion- and corrosion resistances.

Method of manufacturing the tube construction includes the following steps:
(a) Thermo-chemical, diffusion treatment of the internal tube in a furnace with carbonitriding atmosphere to form carbonitride hard layers having hardness in the range of 57-59 HRc on both sides of the internal tube. The depth of the hard layers is in the range of 0.4-0.5 mm.
(b) Depositing the inorganic alumina-based adhesive (Aremco® Ceramacast 510) onto the CWRC surface;
(c) Assembling by inserting the internal tube with CWRC and adhesive into the external tube,
(d) Bonding the tubes at 100-120° C. for 3 h to produce a single solid multilayer tube with the corrosion- and wear-resistant coating 3 embedded between two steel layers, and with additional open surface coating layer 6;
(a) Bending the multilayer tube structure to form 30° bent tube. The resulting product is high-strength steel tube with the interior double-layer abrasion-resistant protective coating.

### EXAMPLE 9

A Grade 5 titanium tube construction consists of;
an external tube 1 having 50 mm OD and wall thickness of 3 mm,
an internal glass tube 2 having 40 mm OD and wall thickness 1.5 mm,
a corrosion- and wear resistant alumina coating (CWRC) layer 3 between external and internal tubes, so the CWRC coating is embedded in the tube structure,
a bond layer 4 which is an adhesive joint layer about 0.05 mm thick between CWRC and the inner surface of the external tube. The length of tubes is 450 mm.

CWRC is plasma sprayed alumina and the bond layer is an inorganic alumina-based adhesive:

The manufacture of the tube construction included the following steps:
(a) Plasma spraying alumina ceramic powder onto the outer surface of the internal glass tube to form dense ceramic CWRC, with a thickness of about 2 mm;
(b) Depositing the inorganic adhesive (Aremco® Ceramacast 510) onto the CWRC surface;
(c) Inserting the internal glass tube with CWRC and adhesive into the external tube;
(d) Bonding the tubes at 100-120° C. for 3 h to produce a single solid multilayer tube with the corrosion- and wear-resistant alumina coating embedded between titanium and glass tube layers, and
(e) Breaking the internal glass tube in order to remove it. The resulting product is a titanium tube with the interior 2 mm alumina coating.

### EXAMPLE 10

A stainless steel tube construction consists of;
an external stainless steel AISI304 tube 1 having 50 mm OD and wall thickness of 3 mm,
an internal aluminum A3003 tube 2 having 40 mm OD and wall thickness 1 mm,
a corrosion- and wear resistant alumina coating (CWRC) layer 3 between external and internal tubes, so the CWRC coating is embedded in the tube structure,
a bond layer 4 which is an adhesive joint layer about 0.05 mm thick between CWRC and the inner surface of the external tube. The length of tubes is 450 mm.

CWRC is plasma sprayed alumina and the bond layer is an organic epoxy-based high-performance adhesive:

The manufacture of the tube construction included the following steps:
(a) Plasma spray deposition of alumina ceramic powder onto the outer surface of the internal aluminum tube to form dense ceramic CWRC with a thickness of about 2 mm;
(b) Depositing the organic epoxy-based adhesive (Aremco® #2300) onto the CWRC surface;
(c) Inserting the internal aluminum tube with CWRC and adhesive into the external tube;
(d) Bonding the two tubes at room temperature to produce a single solid multilayer tube with the corrosion- and wear-resistant alumina coating embedded between two tube layers. The resulting product is a stainless steel tube with the interior 2 mm alumina coating, and with 1 mm aluminum sacrificial layer.

We claim:

1. A construction of tube with an embedded corrosion-resistant and wear-resistant interior coating where said construction comprises:
an external tube layer,
an embedded corrosion- and wear-resistant interior coating,
a bond layer between the external tube and the coating, and
an internal tube layer,
wherein the corrosion- and wear-resistant coating (CWRC) is preliminary bonded to the outside surface of the internal tube layer.

2. The construction of tube with an embedded corrosion-resistant and wear-resistant interior coating according to claim 1, wherein an additional thin layer of crack-healing material is placed between the internal tube and CWRC layers, wherein the melting temperature of said crack-healing material is lower than that of CWRC material.

3. The construction of tube with an embedded corrosion-resistant and wear-resistant interior coating according to claim 1, wherein both external and internal tube layers are made from at least one material selected from carbon steel, alloy steel, stainless steel, cast iron, titanium and titanium alloys, aluminum and aluminum alloys, copper or copper alloys, refractory metals and alloys, plastics and polymers, reinforced plastics and polymers, glass, ceramics, refractory inorganic materials, metal matrix composites, ceramic composites, hybrid materials, and any combinations thereof

4. The construction of tube with an embedded corrosion-resistant and wear-resistant interior coating according to claim 1, wherein both external and internal tube layers are made from the same material, and the material of CWRC has corrosion resistance and wear-resistance superior to those of external tube layer.

5. The construction of tube with an embedded corrosion-resistant and wear-resistant interior coating according to claim 1, wherein the internal tube layer is made from glass, glass-ceramic, and plastic, preferably glass tube.

6. The construction of tube with an embedded corrosion-resistant and wear-resistant interior coating according to claim 1, wherein the corrosion- and wear-resistant coating has a multilayer structure with the internal tube layer embedded between coating layers.

7. The construction of tube with an embedded corrosion-resistant and wear-resistant interior coating according to claim 1, wherein the bond layer is made from at least one material selected from solders, brazing filler metals, powders, sprayed compounds, organic adhesives, inorganic adhesives, cellulose binders, hydraulic binders including cement-based binders, composite solders, hybrid organic-inorganic adhesives and binders, and mixtures thereof

8. The construction of tube with an embedded corrosion-resistant and wear-resistant interior coating according to claim 2, wherein the crack-healing layer is made from at least one material selected from low melting temperature glass or glass-ceramics, low melting temperature metals and alloys, solders, brazing fluxes, soldering fluxes, powders, sprayed compounds, rosin, adhesives, plastics, reinforced plastics, or mixture thereof, whereby the liquidus temperature of said crack-healing material is lower than that of the CWRC material.

9. A method for manufacturing a tube with an embedded corrosion-resistant and wear-resistant coating, wherein the tube comprises an external tube layer, a bond layer, an interior corrosion- and wear-resistant coating, and an internal tube layer, the method includes:
(a) depositing the corrosion- and wear-resistant coating (CWRC) onto outer surface of the internal tube,
(b) depositing a bonding material onto CWRC,
(c) inserting the internal tube with deposited CWRC and bond material into the external tube to provide an embedded CWRC between external and internal tube layers, and
(d) bonding the external tube with the internal tube having deposited CWRC and bond material.

10. The method for manufacturing a tube with an embedded corrosion-resistant and wear-resistant coating according to claim 9, wherein a crack-healing agent is deposited onto the surface of internal tube before depositing the corrosion- and wear-resistant coating (CWRC), and CWRC is deposited onto the crack-healing agent.

11. The method for manufacturing a tube with an embedded corrosion-resistant and wear-resistant coating according to claim 10, wherein a crack-healing agent is deposited onto the surface of internal tube together with the corrosion- and wear-resistant coating.

12. The method for manufacturing a tube with an embedded corrosion-resistant and wear-resistant coating according to claim 9, wherein the internal tube is subjected to deformation by increasing its diameter after inserting into the external tube and before bonding the tube layers.

13. The method for manufacturing a tube with an embedded corrosion-resistant and wear-resistant coating according to claim 9, wherein the internal tube is subjected to deformation by increasing its diameter after inserting into the external tube and after bonding the tube layers.

14. The method for manufacturing a tube with an embedded corrosion-resistant and wear-resistant coating according to claim 9, wherein bonding of the embedded corrosion-resistant and wear-resistant coating with the external tube is carried out by method selected from soldering, brazing, fusion welding, diffusion welding, friction welding, gluing, adhesive bonding, bonding with cement-containing and any other hydraulic-setting binders, and combination of these methods.

15. The method for manufacturing a tube with an embedded corrosion-resistant and wear-resistant coating according to claim 9, wherein the bonded tube construction is subjected to bending followed by heating for melting the crack-healing agent, which is filling cracks in CWRC and solidifies after cooling.

16. The method for manufacturing a tube with an embedded corrosion-resistant and wear-resistant coating according to claims 12 and 13, wherein the deformation is carried out at the temperature of ambient atmosphere.

17. The method for manufacturing a tube with an embedded corrosion-resistant and wear-resistant coating according to claims 12 and 13, wherein the deformation is carried out after heating the tube to the temperature above the temperature of ambient atmosphere.

18. The method for manufacturing a tube with an embedded corrosion-resistant and wear-resistant coating according to claims 10 and 11, wherein the bonded tube structure is heated to melt the crack-healing agent, and the internal tube is removed from the tube structure before the solidification of said crack-healing agent.
